(19) United States
(12) Patent Application Publication
(10) Pub. No.: US 2012/0081747 A1
(43) Pub. Date: Apr. 5, 2012

(54) PRINTER WITH RFID WRITER, CONTROL METHOD, AND SYSTEM FOR PRODUCING PRINT MEDIA WITH AN RFID TAG

(75) Inventor: Naoki Kobayashi, Matsumoto-shi (JP)

(73) Assignee: Seiko Epson Corporation, Tokyo (JP)

(21) Appl. No.: 13/251,407

(22) Filed: Oct. 3, 2011

(30) Foreign Application Priority Data
Oct. 1, 2010 (JP) 2010-223576

(51) Int. Cl. G06F 3/12

(52) U.S. Cl. 358/1.15

(57) ABSTRACT

A label printer with RFID writer enables easily building a RFID label production system. The label printer with RFID writer includes an input unit that receives a label production command from a host computer, a print mechanism that prints label data contained in the print label command received by the input unit on a label with an RFID tag, a data writing unit that writes data to the RFID tag of the label, a search unit that detects if a barcode command is contained in the print label command, and a data generating unit that generates data to be written to the RFID tag if a barcode command is detected.

### BACKGROUND

1. Technical Field

The present invention relates to a printer that has an RFID writer writing data to the RFID tag while printing on labels and other types of print media with an embedded RFID (radio frequency identification) tag. The invention relates more specifically to a printer with RFID writer that can generate RFID tag write data based on a print command input from an external source, a method of controlling the printer, and a system for producing print media with an RFID tag using the printer with RFID writer.

2. Related Art

Labels with an embedded RFID tag (“RFID labels” below) are commonly used for distribution management in the distribution and shipping industries, for example. Control information such as a barcode used for distribution management is printed on the RFID label, and data representing the same control information is also written to the RFID tag. By reading the RFID label by means of a RFID writer, the control information can be acquired and used for routing or other distribution management operation even when the barcode printed on the label is soiled and cannot be read.

Japanese Unexamined Patent Appl. Pub. JP-A-2009-110266 teaches a label production device for producing this type of RFID label. This label production device generally consists of a computer and a label printer with a RFID writer, supplies a label production command generated by the computer (a command for printing the label and a command for writing the RFID tag) to the label printer with RFID writer, and causes the label printer with RFID writer to print the label and write the RFID tag. If this label production device is used in a network-connected label production system as taught in Japanese Unexamined Patent Appl. Pub. JP-A-2010-67279, RFID labels can be conveniently produced by label printers connected to different terminals.

If a user of a common label printer that does not have a RFID writer wants to introduce a label printer with RFID writer in order to produce RFID labels, however, it is not possible to simply replace the label printer, and the application deployed on the label production system including both a computer and label printer must be completely replaced. More specifically, the computer must generate and supply commands for writing the RFID tags in addition to commands for printing labels to the label printer with RFID writer. In the case of the network-connected label production system taught in JP-A-2010-67279, a new network application must be developed in order to introduce a label printer with RFID writer. Because there is also the cost of installation, a conventional label production system cannot be easily converted to a system for producing labels with an RFID tag.

This problem also occurs when converting a print media production system that produces print media other than labels to a print media with RFID tag production system for producing print media with RFID tags (“RFID print media” below).

### SUMMARY

A printer with RFID writer according to the present invention enables converting a print media production system that cannot write RFID tags to a print media production system that can produce RFID print media having data written to the RFID tags without changing the application to generate and supply RFID tag write commands to the printer. The invention also provides a RFID print media production system that includes the printer with RFID writer.

A first aspect of the invention is a printer with RFID writer, including: an input unit to which a print command is input; a print unit that prints print data contained in the print command input to the input unit to a print medium having an RFID tag; a data writing unit that writes data to the RFID tag of the print medium; a search unit that determines if predetermined specific information is contained in the print command input to the input unit; and a data generating unit that, when the specific information is detected by the search unit, generates write data to be written to the RFID tag by the data writing unit.

Preferably, the print medium with RFID tag is a label with an RFID tag.

In a printer with RFID writer according to another aspect of the invention, a character string representing a barcode command name is detected as the specific information when barcode information is written to the RFID tag; and the data generating unit generates barcode write data corresponding to the barcode data contained in the barcode command as the write data.

A printer with RFID writer according to another aspect of the invention preferably also has a configuration/changing unit that can configure or change the specific information detected by the search unit; and the data generating unit generates the write data based on information contained in the specific information detected by the search unit. This enables writing information other than barcode information to the RFID tag.

Another aspect of the invention is a printer with RFID writer as described above, and a computer that generates and supplies the print command to the printer with RFID writer.

### EFFECT OF THE INVENTION

When an input print command is searched and found to contain specific information such as a barcode command name, the write data generating unit of a printer with RFID writer according to the invention generates write data to be written to the RFID tag. A print medium with an RFID tag can therefore be produced without converting the input print command to a RFID tag write command or a command including write data for creating a RFID print medium.

By replacing the printer in a print media production system that has a printer without an RFID tag writing function with the printer with RFID writer according to the invention, a system for producing print media with an RFID tag can be easily constructed without greatly changing the system application.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the control system of a RFID label production system according to the invention.

FIG. 2 shows an example of a barcode print command.

FIG. 3 is a flow chart of the RFID label production operation.

### DESCRIPTION OF EMBODIMENTS

A RFID label production system according to a preferred embodiment of the present invention is described below with reference to the accompanying figures.

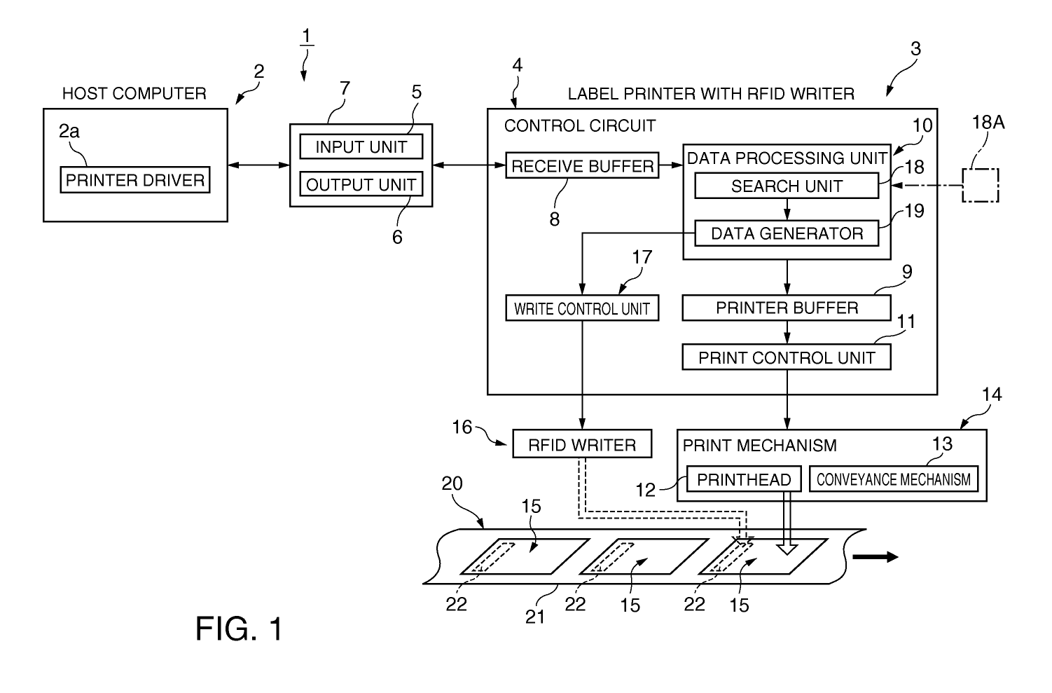

FIG. 1 is a block diagram showing primarily the control system of the RFID label production system according to this embodiment of the invention. This RFID label production system 1 includes a host computer 2 and a label printer with RFID writer (RFID label printer) 3. The RFID label printer 3 includes a control circuit 4, communication interface 7, print mechanism 14, and RFID writer 16.

The control system of the RFID label printer 3 includes the control circuit 4, which includes a CPU, ROM, and RAM. The communication interface 7 including an input unit 5 and output unit 6 for communicating with the host computer 2 is connected to the control circuit 4.

The control circuit 4 also includes a receive buffer 8 that stores data received from the host computer 2 through the input unit 5, and a print buffer 9 that temporarily stores image data for printing. The control circuit 4 functions as different control units by executing control programs stored in ROM using RAM as working memory as controlled by the CPU.

More specifically, the control circuit 4 functions as a data processing unit 10 that reads data stored in the receive buffer 8 through the input unit 5, interprets the commands, and executes the processes specified by the data.

The control circuit 4 also functions as a print control unit 11 that controls printing the print data in the print buffer 9. The print control unit 11 controls driving the print mechanism 14 (print unit) including the printhead 12 and conveyance mechanism 13, conveys the RFID label 15 or other print medium passed the printing position of the printhead 12, and drives the printhead 12 synchronized to media conveyance to print the print data (label printing data, barcode data).

The control circuit 4 also functions as a write control unit 17 that controls driving the RFID writer 16 (data write unit) to write data in the RFID tag 22 of the RFID label 15.

The data processing unit 10 has a search unit 18 that determines based on the result of command interpretation whether predetermined specific information, such as a control string representing a barcode command name in this embodiment, was received. The data processing unit 10 also has a data generator 19 that, if a control string representing a barcode command name is found, extracts the barcode data received following the control string, generates the data to be written by the RFID writer 16, and supplies the data to the write control unit 17.

The RFID labels 15 are supplied as continuous RFID label paper 20. RFID label paper 20 has RFID labels 15 of a constant width and constant length removably affixed with a specific interval therebetween along the length of the surface of a web liner 21 with an RFID tag 22 disposed between the liner 21 and each RFID label 15.

The commands sent from the host computer 2 to the RFID label printer 3 include bit image process commands controlling transmitting and printing specific amounts of bit image data. A print label command that specifies label printing, and a print barcode command that specifies printing a barcode, are examples of bit image process commands.

A bit image process command includes a bit image command header and bit image data payload. The bit image command header includes control parameters declaring, for example, a control string indicating the command name, the bit image data print mode (including vertical and horizontal dot density), and the amount of data. The bit image payload contains the actual bit image data in a specific order.

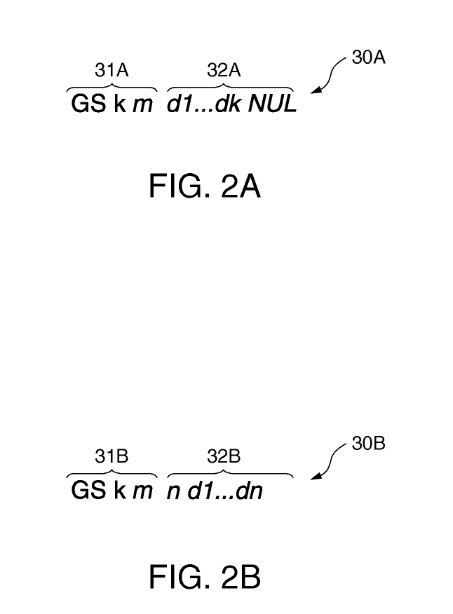

FIG. 2A and FIG. 2B show different examples of barcode commands. Barcode commands 30A and 30B are generally ASCII strings. The barcode command 30A shown in FIG. 2A includes a barcode command header 31A (GS k m) and barcode data payload 32A (d1-dk NUL). The barcode command 30B shown in FIG. 2B includes a barcode command header 31B (GS k m) and barcode data payload 32B (n d1-dn).

In barcode command headers 31A and 31B, “GS” is a control code denoting a barcode command name, “k” is a control parameter denoting the data count, and “m” is a control parameter denoting the barcode system (type of barcode).

In barcode data payload 32A, “d1-dk” represents the data, and “NUL” denotes the end of the data.

In barcode data payload 32B, “n” denotes the data count, and “d1-dn” represent the data.

In this embodiment of the invention, when the search unit 18 of the control circuit 4 of the RFID label printer 3 finds the special character string representing a barcode command name, that is, finds the control string [GS k m] in the barcode command header 31A, the data generator 19 generates RFID tag write data containing the barcode information represented by the barcode data payload following the barcode command header 31A.

The write control unit 17 writes the generated data to the RFID tag 22 by means of the RFID writer 16. As a result, specific label information and a barcode are printed on the surface of the produced RFID label 15, and barcode information corresponding to the printed barcode is written to the RFID tag 22.

### RFID Label Production

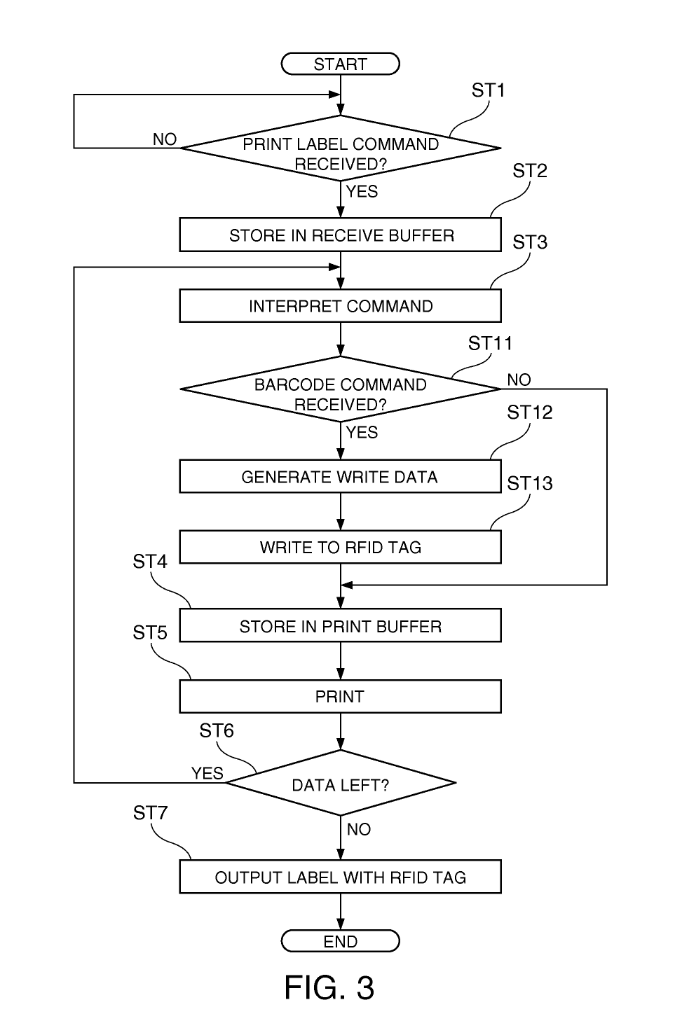

FIG. 3 is a flow chart of the RFID label production operation performed by the RFID label production system 1 described above. Data for printing a label is produced by the host computer 2 before label production starts. This data may include data for printing a specific label without a barcode, or data for printing a label with a barcode. To produce a label printed with this information, a print label command is generated by the printer driver 2a of the host computer 2 and sent to the RFID label printer 3.

The RFID label printer 3 receives the print label command through the input unit 5 of the communication interface 7, and stores the command in the receive buffer 8 (steps ST1, ST2). The print label command stored in the receive buffer 8 is then interpreted by the data processing unit 10 (step ST3).

If the search unit 18 of the data processing unit 10 finds the character string [GS k m] denoting a barcode command, it supplies the following barcode data to the data generator 19 (step ST11 returns Yes). The data generator 19 generates the RFID tag write data representing the same barcode data (step ST12). Once the write data is generated, the write control unit 17 drives the RFID writer 16 to write the generated write data to the RFID tag of the RFID label (step ST13).

All print data, including the barcode data, is written to the print buffer 9 (step ST4). The data written to the print buffer 9 is then printed by the printhead 12 on the RFID label 15 as controlled by the print control unit 11 (step ST5). The barcode found in step ST11 is also printed with the specific label image on the RFID label 15. If there is data in the receive buffer 8 (step ST6 returns Yes), control returns to step ST3 for command interpretation. When there is no data left in the receive buffer 8 as a result of repeating these steps (step ST6 returns No), an RFID label 15 is issued with a barcode printed on the label surface and the barcode information represented by the barcode written to the RFID tag (step ST7).

However, if a barcode command is not found, write data for recording by the RFID writer 16 is not generated (step ST11 returns No). Print data is therefore written to the print buffer 9 in this case (step ST4). The data written to the print buffer 9 is printed on the RFID label 15 by the printhead 12 as controlled by the print control unit 11 (step ST5). More specifically, because the label is only printed, a RFID label 15 is issued (step ST7) with no data written to the RFID tag 22 in the same way as with a common label printer.

The print label command sent from the host computer 2 in a RFID label production system 1 according to this embodiment of the invention is thus the same as a command sent to a label printer that does not have a RFID writer 16. As a result, a RFID label production system 1 can be constructed without changing the application running on the label production system by replacing the label printer used in an existing label production system with the RFID label printer 3 according to this embodiment of the invention.

### Other Embodiments

When a barcode command is found in this embodiment of the invention, data corresponding to the barcode data is generated and written to the RFID tag. Alternatively, however, specific information representing management information other than a barcode command contained in a command supplied from a computer could be detected, and write data corresponding thereto could be generated and written to the RFID tag.

As indicated by the imaginary lines in FIG. 1, a configuration and editing unit 18A that can configure or change the specific information searched for by the search unit 18 could also be provided, and the specific information to be detected could be set and changed by means of the configuration and editing unit 18A when the printer with RFID writer is shipped. In this case, the data generator 19 generates the write data according to the specific information to be detected after being configured or changed.

The foregoing embodiment of the invention describes a RFID label production system, but the invention can also be applied to other systems to produce RFID print media other than labels. For example, the invention can also be used in medical information management systems. Patient identification errors and other medical treatment errors are prevented by using medical information management systems to print patient identification information such as the patient's name on a wristband that is worn by the patient by means of a local printer. However, by replacing a printer used in such a system with a printer having an RFID writer according to the invention, wristbands with an RFID tag can be produced. Because RFID tags enable contactlessly reading information, this makes patient management easier than when barcodes are used.

The printer with RFID writer and RFID print media production system according to the invention can also be used in management systems other than medical information management systems, including product distribution, library management, and other fields.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printer with RFID writer, comprising:
an input unit to which a print command is input;
a print unit that prints print data contained in the print command input to the input unit to a print medium having an RFID tag;
a data writing unit that writes data to the RFID tag of the print medium;
a search unit that determines if predetermined specific information is contained in the print command input to the input unit; and
a data generating unit that, when the specific information is detected by the search unit, generates write data to be written to the RFID tag by the data writing unit.

2. The printer with RFID writer described in claim 1, wherein:
the print medium with RFID tag is a label with an RFID tag.

3. The printer with RFID writer described in claim 1, wherein:
the specific information is a character string representing a barcode command name; and
the data generating unit generates barcode write data corresponding to the barcode data contained in the barcode command as the write data.

4. The printer with RFID writer described in claim 1, further comprising:
a configuration/changing unit that can configure or change the specific information detected by the search unit;
wherein the data generating unit generates the write data based on information contained in the specific information detected by the search unit.

5. A control method for a printer with RFID writer, comprising steps of:
receiving a print command;
printing print data contained in the print command received in the receiving step to a print medium with an RFID tag;
writing data to the RFID tag of the print medium;
searching for predetermined specific information in the print command received in the receiving step; and
generating write data that is written to the RFID tag in the data writing step if the specific information is detected in the search step.

6. The control method for a printer with RFID writer described in claim 5, wherein:
the print medium with RFID tag is a label with an RFID tag.

7. The control method for a printer with RFID writer described in claim 5, wherein:
the specific information is a character string representing a barcode command name; and
the data generating step generates barcode write data corresponding to the barcode data contained in the barcode command as the write data.

8. The control method for a printer with RFID writer described in claim 5, further comprising:
a step of configuring or changing the specific information detected in the search step;
wherein the data generating step generates the write data based on information contained in the specific information detected by the search unit.

9. A system for producing a print medium with an RFID tag, comprising:
a printer with RFID writer as described in any of claims 1 to 4; and
a computer that generates and supplies the print command to the printer with RFID writer.
